(19) United States
(12) Patent Application Publication
(10) Pub. No.: US 2010/0318856 A1
(43) Pub. Date: Dec. 16, 2010

(54) RECORDING MEDIUM STORING MONITORING PROGRAM, MONITORING DEVICE, AND MONITORING METHOD

(75) Inventor: Taketoshi YOSHIDA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/784,012

(22) Filed: May 20, 2010

(30) Foreign Application Priority Data
Jun. 16, 2009 (JP) 2009-143630

(51) Int. Cl. G06F 11/34; G06F 17/30

(52) U.S. Cl. 714/47; 707/723; 714/E11.2; 707/E17.014

(57) ABSTRACT

A monitoring device accesses a database storing, for each of a plurality of failure cases that occurred in a monitored device, a group of past monitoring data items each representing respective measured values of monitoring items of the monitored device measured until a time of occurrence of a failure case. The device receives, from the monitored device, a current monitoring data item representing current measured values of the plurality of monitoring items. The device calculates, for each of past monitoring data items stored in the database, a similarity degree between a past monitoring data item and a current monitoring data item on the basis of the respective measured values of the plurality of monitoring items. The device determines, among the plurality of failure cases, a failure case predicted to occur in the monitored device, on the basis of the calculation result. The device outputs the determination result.

### CROSS-REFERENCE TO RELATED APPLICATIONS

This application is based upon and claims the benefit of priority of the prior Japanese. Patent Application No. 2009-143630, filed on Jun. 16, 2009, the entire contents of which are incorporated herein by reference.

### FIELD

Various embodiments described herein relate to a field of monitoring an operating state of a device.

### BACKGROUND

In recent years, along with an enormous increase in size and increased complexity of data centers, a work load required to monitor an operating state of an electronic device (e.g., a calculator, a router, and a switch) has been increasing. Meanwhile, to maintain the service quality of the data centers, the customer service operating on a calculator needs to continue to stably operate without being affected by a failure and so forth.

In the past, there has been a technique of assessing the influence of the abnormality of plant equipment in a nuclear power plant, a thermal power plant, and so forth on the plant operation, to thereby determine the method of checking the plant equipment. Further, there has been a technique of accumulating, in a DB (database), graph data representing a graph of failure cases occurred in the past, accessing the DB by using graph data representing a graph of a currently occurring failure case, and retrieving measures effective in coping with a similar failure case occurred in the past.

According to the typical techniques described above and similar others, however, the cause of a failure is identified on the basis of an ex post result. Therefore, there is an issue of difficulty in predicting and preventing a failure and thus difficulty in taking appropriate prior measures before the occurrence of the failure. As a result, there arises an issue of the influence of the failure on the customer service operating on a calculator and the resultant deterioration of the service quality.

### SUMMARY

A monitoring device comprises a database configured to store, for each of a plurality of failure cases that have occurred in a monitored device, a group of past monitoring data items each representing the respective measured values of a plurality of monitoring items of the monitored device measured until a time of occurrence of a failure case. The device includes a receiving unit configured to receive, from the monitored device, a current monitoring data item representing the current measured values of the plurality of monitoring items. The device includes a calculation unit configured to calculate, for each of past monitoring data items stored in the database, a similarity degree between a past monitoring data item and a current monitoring data item based on the respective measured values of the plurality of monitoring items. The device includes a determination unit configured to determine, among the plurality of failure cases, a failure case predicted to occur in the monitored device, based on the calculation result. The device comprises an output unit configured to output the determination result.

The objects and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an explanatory diagram illustrating an example of a system configuration of a data center;

FIG. 2 is a block diagram illustrating a hardware configuration of a monitoring device;

FIG. 3 is an explanatory diagram illustrating a specific example of a monitoring data item;

FIG. 4 is an explanatory diagram illustrating an example of a content stored in a failure case DB;

FIG. 5 is a block diagram illustrating a functional configuration of a monitoring device;

FIG. 6 is an explanatory diagram illustrating an example of a content stored in a similarity degree table;

FIG. 7 is an explanatory diagram illustrating a specific example of a failure prediction report;

FIG. 8 is an explanatory diagram illustrating a degree of temporal urgency up to an occurrence of a failure case;

FIG. 9 is an explanatory diagram illustrating an example of a content stored in a failure list;

FIG. 10 is a flowchart illustrating an example of a monitoring process procedure by a monitoring device;

FIG. 11 is a flowchart illustrating an example of a specific process procedure of a similarity degree calculation process;

FIG. 12 is a flowchart illustrating an example of a specific process procedure of a first weighting process;

FIG. 13 is a flowchart illustrating an example of another monitoring process procedure by a monitoring device; and

FIG. 14 is a flowchart illustrating an example of a specific process procedure of a second weighting process.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

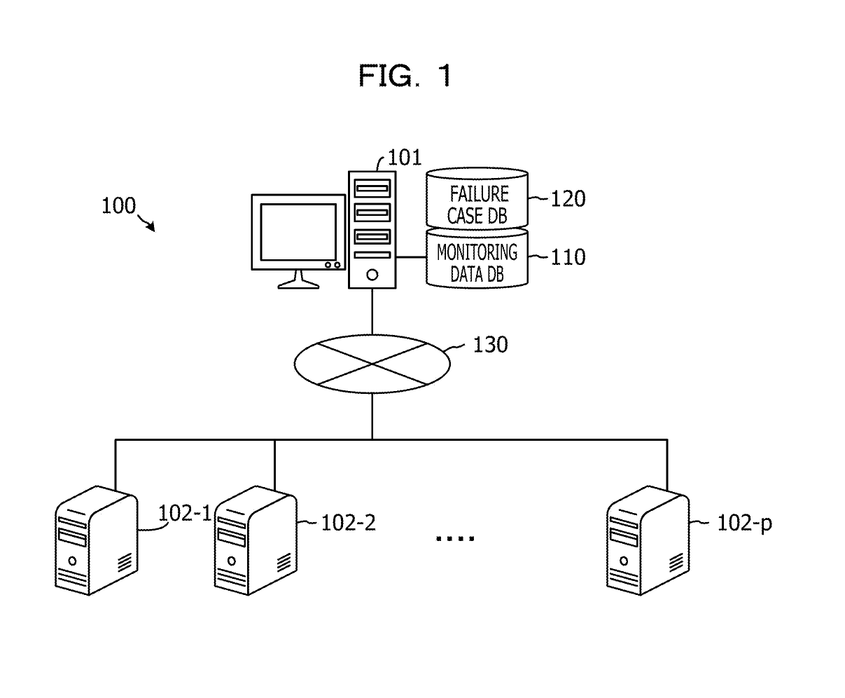

A system configuration of a data center according to an embodiment will be described. FIG. 1 is an explanatory diagram illustrating an example of a system configuration of a data center. In FIG. 1, a monitoring device 101 of a data center 100 and monitored devices 102-1 to 102-p are mutually communicably connected via a network 130, such as the Internet, a LAN (Local Area Network), and a WAN (Wide Area Network).

The monitoring device 101 includes a monitoring data DB 110, and has a function of receiving monitoring data items from the monitored devices 102-1 to 102-p. Herein, the monitoring data DB 110 is a database which stores the monitoring data items received from the monitored devices 102-1 to 102-p.

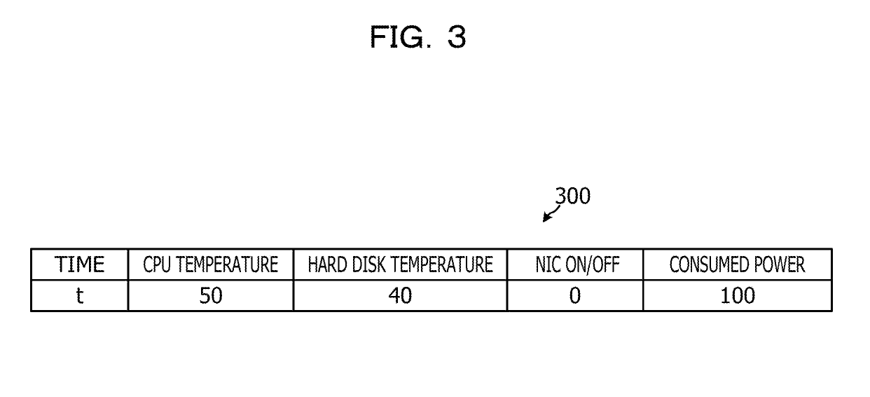

Further, a monitoring data item is information representing respective states of a plurality of monitoring items (items to be monitored) of the monitored devices 102-1 to 102-p. The monitoring items include, for example, the CPU (Central Processing Unit) (processor) temperature, the hard disk temperature, the memory temperature, the NIC (Network Interface Card) ON/OFF, and the consumed power of the monitored devices 102-1 to 102-p. A specific example of the monitoring data item will be described later with reference to FIG. 3. Further, while specific examines of items to be monitored are described herein, the present invention is not limited to monitoring with respect to any particular item. Instead, any item, information and/or characteristic with respected to the devices 102-1 to 102-p may be monitored.

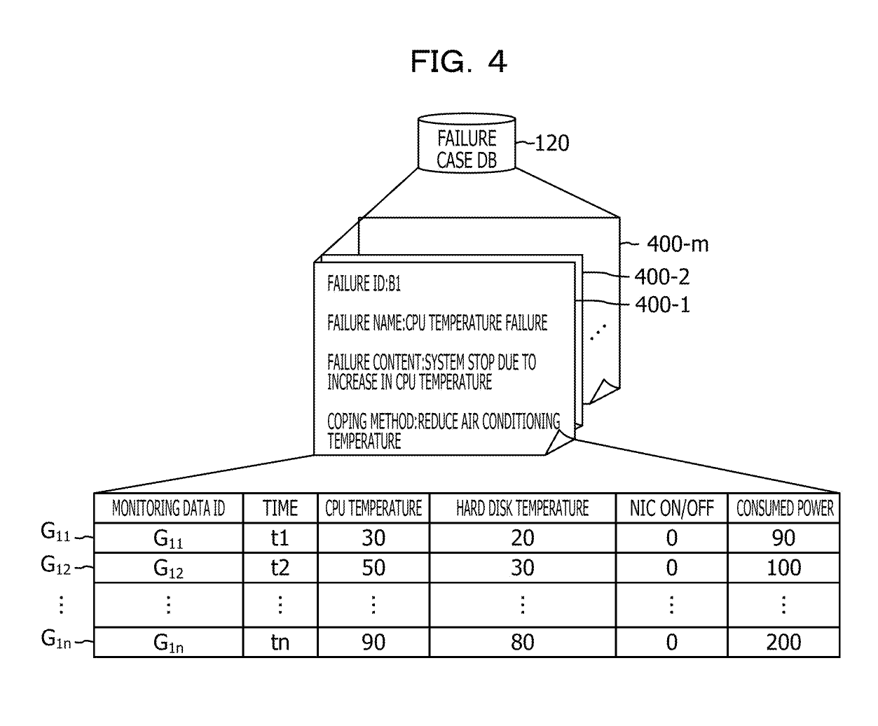

Further, the monitoring device 101 includes a failure case DB 120, and has a function of identifying a failure predicted to occur in the future in the monitored devices 102-1 to 102-p. Herein, the failure case DB 120 is a database which stores, for each of failure cases that has occurred in the past in the monitored devices 102-1 to 102-p, monitoring data items of a predetermined period until a time of occurrence of the failure case. The content stored in the failure case DB 120 will be described later with reference to FIG. 4.

Further, the monitoring device 101 has a function of controlling the monitored devices 102-1 to 102-p. Specifically, for example, the monitoring device 101 powers off one of the monitored devices 102-1 to 102-p, in which a failure has occurred, and temporarily cuts off the monitored device from the network 130. Further, the monitoring device 101 has a function of migrating or transferring an application operating on the one of the monitored devices 102-1 to 102-p, in which a failure has occurred, to another one of the monitored devices 102-1 to 102-p.

The monitored devices 102-1 to 102-p may be, for example, calculators which execute applications and jobs. Further, the monitored devices 102-1 to 102-p may be routers or switches for connecting a plurality of calculators, or may be redundant power supply devices for stably supplying power.

The monitored devices 102-1 to 102-p have a function of measuring respective states of the plurality of monitoring items and transmitting a measurement result to the monitoring device 101 as the monitoring data item. Specifically, for example, the monitored devices 102-1 to 102-p measure the respective states of the plurality of monitoring items in accordance with a transmission request received from the monitoring device 101, and transmit the monitoring data item to the monitoring device 101. The transmission request for the monitoring data item is transmitted from the monitoring device 101 at predetermined time intervals (e.g., five minutes).

Further, the monitored devices 102-1 to 102-p transmit a failure data item to the monitoring device 101 in an event of a failure of some sort. Specifically, for example, if the CPU temperature exceeds a predetermined value, or if a failure occurs in the hard disk, the monitored devices 102-1 to 102-p transmit the failure data item to the monitoring device 101. The failure data item includes information for identifying the failure (e.g., failure name).

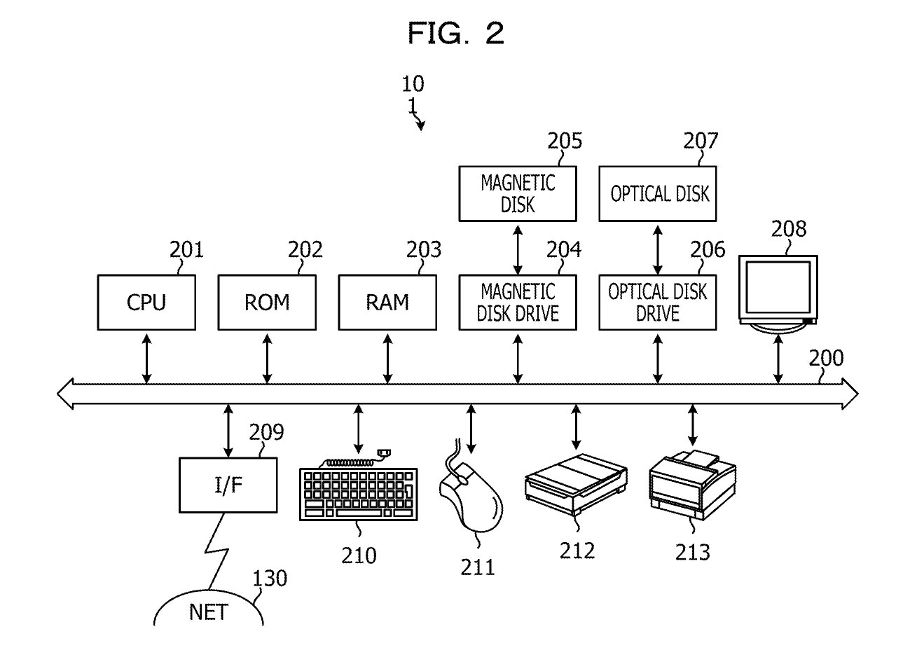

FIG. 2 is a block diagram illustrating a hardware configuration of a monitoring device 101. In FIG. 2, the monitoring device 101 includes a CPU 201, a ROM (Read-Only Memory) 202, a RAM (Random Access Memory) 203, a magnetic disk drive 204, a magnetic disk 205, an optical disk drive 206, an optical disk 207, a display 208, an I/F (Interface) 209, a keyboard 210, a mouse 211, a scanner 212, and a printer 213. Further, the respective components are connected to one another by a bus 200.

Herein, the CPU 201 is in charge of the overall control of the monitoring device 101. The ROM 202 stores programs such as a boot program. The RAM 203 is used as a work area for the CPU 201. The magnetic disk drive 204 controls the data reading and writing from and to the magnetic disk 205 in accordance with the control of the CPU 201. The magnetic disk 205 stores data written in accordance with the control of the magnetic disk drive 204.

The optical disk drive 206 controls the data reading and writing from and to the optical disk 207 in accordance with the control of the CPU 201. The optical disk 207 stores data written in accordance with the control of the optical disk drive 206, and allows a computer to read the data stored in the optical disk 207.

The display 208 displays a cursor, an icon, and a toolbox, and also data such as text, image, and functional information. For example, a CRT (Cathode Ray Tube), a TFT (Thin Film Transistor) liquid crystal display, or a plasma display can be employed as the display 208.

The interface (hereinafter abbreviated as “I/F”) 209 is connected to the network 130, such as the LAN, the WAN, and the Internet, through a communication line, and is connected to another device via the network 130. Further, the I/F 209 serves as an interface between the network 130 and the interior of the monitoring device 101, and controls the input and output of data from and to an external device. For example, a modem or a LAN adapter can be employed as the I/F 209.

The keyboard 210 includes keys used to input characters, numbers, a variety of instructions, and so forth, and performs the input of data. Further, the keyboard 210 may be a touch-panel input pad or a numeric keypad. The mouse 211 performs the movement of a cursor, the selection of a range, the movement and change in size of a window, and so forth. The mouse 211 may be replaced by a trackball or a joystick, as long as the replacing member serving as a pointing device has functions similar to the functions described above.

The scanner 212 optically reads an image and sends image data into the monitoring device 101. The scanner 212 may be provided with an OCR (Optical Character Reader) function. Further, the printer 213 prints image data and text data. For example, a laser printer or an inkjet printer may be employed as the printer 213.

In FIG. 2, the hardware configuration of the monitoring device 101 has been described. A similar hardware configuration can realize the hardware configuration of the monitored devices 102-1 to 102-p (see FIG. 1).

Subsequently, description will be made of a specific example of the monitoring data item transmitted to the monitoring device 101 from a monitored device 102-k (k=1, 2, . . . , or p). FIG. 3 is an explanatory diagram illustrating a specific example of a monitoring data item. In FIG. 3, a monitoring data item 300 includes respective fields for the time, the CPU temperature, the hard disk temperature, the NIC ON/OFF, and the consumed power. With information set in the respective fields, observation results of the plurality of monitoring items are stored as records.

Herein, the time refers to the time of transmission of the monitoring data item 300. The CPU temperature refers to the temperature (° C.) of the CPU included in the monitored device 102-k. The hard disk temperature refers to the temperature (° C.) of the hard disk included in the monitored device 102-k. The NIC ON/OFF refers to the value representing the operating state of the NIC included in the monitored device 102-k. Herein, a value “0” is set if there is no failure in the operating state of the NIC, and a value “1” is set if there is a failure in the operating state of the NIC. The consumed power refers to the consumed power (W) consumed by the monitored device 102-k.

Subsequently, the content stored in the failure case DB 120 illustrated in FIG. 1 will be described. FIG. 4 is an explanatory diagram illustrating an example of the content stored in the failure case DB 120. In FIG. 4, the failure case DB 120 stores failure case data items 400-1 to 400-m relating to a variety of failure cases occurred in the past in the monitored devices 102-1 to 102-p.

Specifically, each of the failure case data items 400-1 to 400-m includes a failure ID (Identifier), a failure name, a failure content, and a coping method. Herein, the failure ID refers to the identifier of a failure case. The failure name refers to the name of a failure. The failure content refers to the specific content of a failure. The coping method refers to the coping measures which should be taken in the event of a failure. In the example of the failure case data item 400-1, the failure name, the failure content, and the coping method of a failure B1 are “CPU TEMPERATURE FAILURE,” “SYSTEM STOP DUE TO INCREASE IN CPU TEMPERATURE,” and “REDUCE AIR CONDITIONING TEMPERATURE,” respectively.

Further, each of the failure case data items 400-1 to 400-m includes a group of chronological monitoring data items of a predetermined time period until the time of occurrence of the failure. In the example of the failure case data item 400-1, the failure case data item 400-1 includes chronological monitoring data items G₁₁ to G₁ₙ of a predetermined time period until the time of occurrence of the failure B1. The monitoring data ID refers to the identifier of a monitoring data item.

Herein, a time tn corresponding to the monitoring data item G₁ₙ, is assumed to be the time of occurrence of the failure B1. Further, the transmission time interval of the monitoring data items transmitted to the monitoring device 101 from the monitored device 102-k (e.g., the time interval between the monitoring data items G₁₁ and G₁₂) is assumed to be five minutes. Herein, if the value n is 60, a time t1 corresponding to the monitoring data item G₁₁ is 295 minutes before the time of occurrence of the failure B1 (a time t60). That is, with the transmission time interval of the monitoring data items set to a predetermined interval, it is possible to calculate the time interval between arbitrary monitoring data items on the basis of the order of transmission from the monitored device 102-k.

In the following description, an arbitrary failure case data item among the failure case data items 400-1 to 400-m will be represented as the “failure case data item 400-i” (i=1, 2, . . . , or m). Further, the group of monitoring data items included in the failure case data item 400-i will be represented as the “monitoring data items Gᵢ₁ to Gᵢₙ.” Further, an arbitrary monitoring data item among the monitoring data items Gᵢ₁ to Gᵢₙ will be represented as the “monitoring data item Gᵢⱼ” (j=1, 2, . . . , or n).

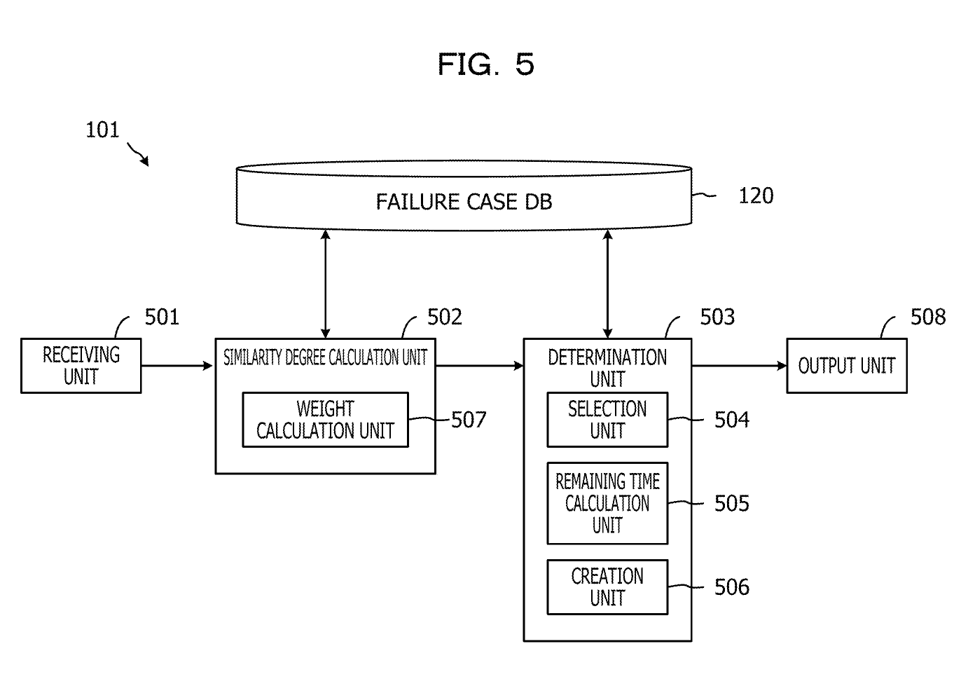

Subsequently, a functional configuration of the monitoring device 101 will be described. FIG. 5 is a block diagram illustrating a functional configuration of the monitoring device 101. In FIG. 5, the monitoring device 101 is configured to include a receiving unit 501, a similarity degree calculation unit 502, a determination unit 503, a selection unit 504, a remaining time calculation unit 505, a creation unit 506, a weight calculation unit 507, and an output unit 508. Specifically, for example, these functions forming a control unit (the receiving unit 501 to the output unit 508) may be realized by a program stored in a storage device, such as the ROM 202, the RAM 203, the magnetic disk 205, and the optical disk 207 illustrated in FIG. 2, and executed by the CPU 201, or are realized by the I/F 209. Alternatively, in part or in whole, functions and operations discussed herein may be implemented using hardware components including hardware units provided to the monitoring device 101.

The receiving unit 501 has a function of receiving, from the monitored device 102-k, a monitoring data item representing current measured values of the plurality of monitoring items (hereinafter referred to as the “current monitoring data item”). Specifically, for example, the receiving unit 501 receives the monitoring data item 300 (see FIG. 3) from the monitored device 102-k via the network 130. The received reception result is stored in a storage device, such as the RAM 203, the magnetic disk 205, and the optical disk 207 illustrated in FIG. 2.

The similarity degree calculation unit 502 has a function of calculating, for an individual past monitoring data item Gᵢⱼ stored in the failure case DB 120 (hereinafter referred to as the “old monitoring data item”), a similarity degree between the old monitoring data item Gᵢⱼ and a current monitoring data item on the basis of respective measured values of the plurality of monitoring items. In the following description, the similarity degree between the current monitoring data item and the old monitoring data item Gᵢⱼ will be represented as the “similarity degree R_{ij.”}

Specifically, for example, the similarity degree calculation unit 502 may calculate the similarity degree Rᵢⱼ by first converting the current monitoring data item and the old monitoring data item Gᵢⱼ into multidimensional vectors by using the plurality of monitoring items as vector components, and then calculating the inter-vector distance between the current monitoring data item and the old monitoring data item G. Herein, the shorter the inter-vector distance between the current monitoring data item and the old monitoring data item Gᵢⱼ is, the higher the similarity degree Rᵢⱼ is.

More specifically, for example, the similarity degree Rᵢⱼ can be calculated from the cosine (cos θ) of the angle θ formed by the multidimensional vector of the current monitoring data item and the multidimensional vector of the old monitoring data item Gᵢⱼ, which is calculated by the similarity degree calculation unit 502 with the use of the following equation (1).

$${R}_{ij} = cos θ = \frac{\vec{{EV}_{ij}} \cdot \vec{N}}{\vert \vec{{EV}_{ij}} \vert \vert \vec{N} \vert} \qquad ( 1 )$$

Herein, \vec{N} represents the multidimensional vector of the current monitoring data item, and \vec{EVᵢⱼ}represents the multidimensional vector of the old monitoring data item Gᵢⱼ.

Herein, it is assumed that the current monitoring data item is the monitoring data item 300, and that the old monitoring data item Gᵢⱼ is the old monitoring data item G₁₁. In this case, the similarity degree R₁₁ between the monitoring data item 300 and the old monitoring data item G₁₁ can be calculated as in the following equation (2), wherein the respective measured values of the monitoring items are substituted in the above equation (1).

R₁₁=(30x50+20x40+0x0+90x100)/{(30−50)²+(20−40)²+(0−0)²+(90−100)²}^{1/2≈}377 (2)

The respective measured values of the monitoring items substituted in the above equation (1) may be weighted. Specifically, for example, the observed value of a monitoring item which is highly possible to cause a serious problem (e.g., NIC ON/OFF) may be multiplied by a times (e.g., 100 times) and substituted in the above equation (1).

Further, the method of calculating the similarity degree Rᵢⱼ is not limited to the above-described method. Specifically, for example, the similarity degree calculation unit 502 may first compare the measured value of one of the monitoring items of the current monitoring data item with the measured value of the same monitoring item of the old monitoring data item Gᵢⱼ, and then count the number of monitoring items, for which the current monitoring data item and the old monitoring data item Gᵢⱼ have the same measured value (or a measured value falling in a predetermined range), to thereby calculate the similarity degree Rᵢⱼ (e.g., the number of items, for which two monitoring data items have the same measured value).

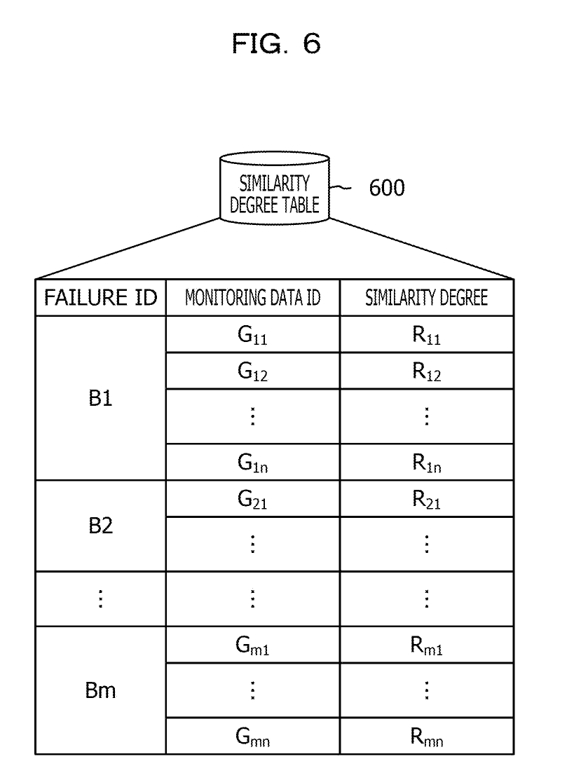

The calculated calculation result is stored in, for example, a similarity degree table 600 illustrated in FIG. 6. FIG. 6 is an explanatory diagram illustrating an example of content stored in the similarity degree table 600. In FIG. 6, the similarity degree table 600 includes respective fields for a failure ID, a monitoring data ID, and a similarity degree. With information set in the respective fields, the respective similarity degrees of the old monitoring data items are stored as records. The similarity degree table 600 is stored in a storage device, such as the RAM 203, the magnetic disk 205, and the optical disk 207, for example.

The determination unit 503 has a function of determining, among a plurality of failure cases B1 to Bm, a failure case Bi predicted to occur in the monitored device 102-k, on the basis of the calculated calculation result. Herein, a specific example of the determination process by the determination unit 503 will be described.

Firstly, the selection unit 504 has a function of selecting, from all of the old monitoring data items stored in the failure case DB 120, an old monitoring data item similar to the current monitoring data item on the basis of the calculation result. Specifically, for example, with reference to the similarity degree table 600, the selection unit 504 may select the old monitoring data item Gᵢⱼ having the highest similarity degree.

Thereafter, with reference to the similarity degree table 600, the determination unit 503 identifies the failure case Bi corresponding to the selected old monitoring data item G.

Then, with reference to the failure case DB 120, the determination unit 503 determines the failure case data item 400-i of the identified failure case Bi to be the failure case predicted to occur in the monitored device 102-k.

The above-described selection unit 504 may select the X number of old monitoring data items of the highest similarity degree by referring to the similarity degree table 600. In this case, the determination unit 503 identifies the failure cases corresponding to the X number of selected old monitoring data items by referring to the similarity degree table 600. The above-described number X can be arbitrarily set. The determined determination result is stored in a storage device, such as the RAM 203, the magnetic disk 205, and the optical disk 207.

The output unit 508 has a function of outputting the determination result. Specifically, for example, the output unit 508 may output the failure case data item 400-i of the failure case Bi in association with the identifier of the monitored device 102-k. With this configuration, it is possible to inform a user of the failure name, the failure content, and the coping method of the failure predicted to occur in the future in the monitored device 102-k.

The types of output include, for example, the display of the result on the display 208, the output of the result to the printer 213 to be printed out, and the transmission of the result to an external device by the I/F 209. Further, the result may be stored in a storage device, such as the RAM 203, the magnetic disk 205, and the optical disk 207.

The remaining time calculation unit 505 has a function of calculating the remaining time remaining until the occurrence of a failure in the monitored device 102-k. Specifically, for example, with the use of the following equation (3), the remaining time calculation unit 505 can calculate, as the remaining time, the time interval between a time tj corresponding to the old monitoring data item Gᵢⱼ selected by the selection unit 504 and the time of occurrence of the failure case Bi. Herein, the time of occurrence of the failure case Bi is the time tn corresponding to the old monitoring data item Gᵢₙ. Further, T represents the remaining time remaining until the occurrence of the failure, and S represents the transmission time interval of the monitoring data items. Further, n represents the number of data items included in the group of old monitoring data items Gᵢₗ to Gᵢₙ for the individual failure case Bi, and j represents an integer from 1 to n.

T=S(n-j)(3)

The creation unit 506 has a function of creating a failure prediction report on the failure predicted to occur in the future in the monitored device 102-k by using the determined determination result and the calculated remaining time. Herein, a specific example of the failure prediction report will be described.

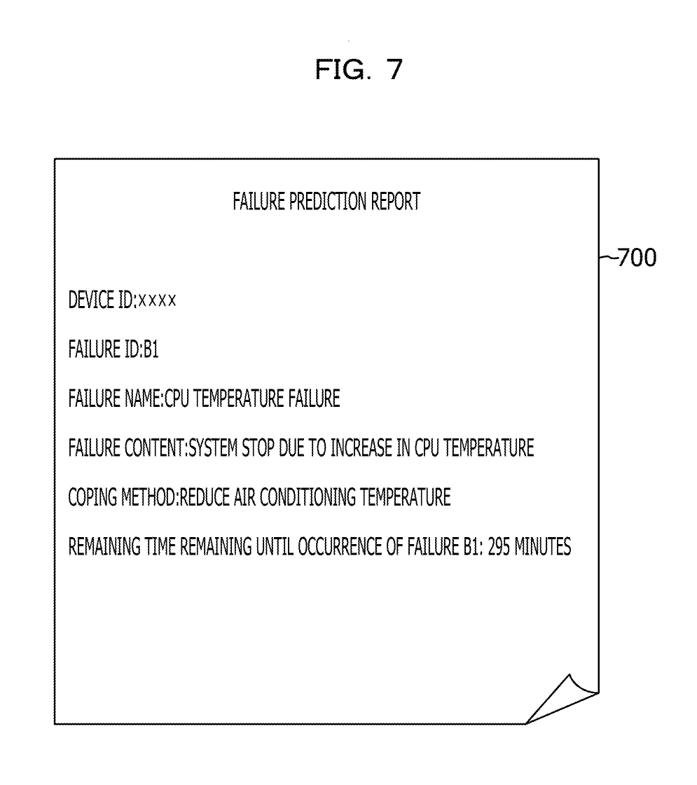

FIG. 7 is an explanatory diagram illustrating a specific example of the failure prediction report. In FIG. 7, a failure prediction report 700 presents a device ID, a failure ID, a failure name, a failure content, a coping method (measure including to address the failure), and a time remaining until an occurrence of the failure. The device ID refers to the identifier of the monitored device 102-k, e.g., the IP (Internet Protocol) address of the monitored device 102-k.

Further, the output unit 508 outputs the created failure prediction report. Specifically, for example, the output unit 508 may output the failure prediction report 700. With this configuration, it is possible to inform a user of a failure name, a failure content, a coping method, and a time remaining until an occurrence of the failure predicted to occur in the future in the monitored device 102-k.

The weight calculation unit 507 has a function of calculating, for the individual old monitoring data item Gᵢⱼ a weight representing the degree of temporal urgency up to the occurrence of the failure case Bi, on the basis of the time of occurrence of the failure case Bi and the time of measurement of the old monitoring data item Gᵢⱼ. Herein, the time of measurement of the old monitoring data item Gᵢⱼ may be, for example, the time at which the respective measured values of the plurality of monitoring items are measured or the time of transmission of the old monitoring data item Gᵢⱼ.

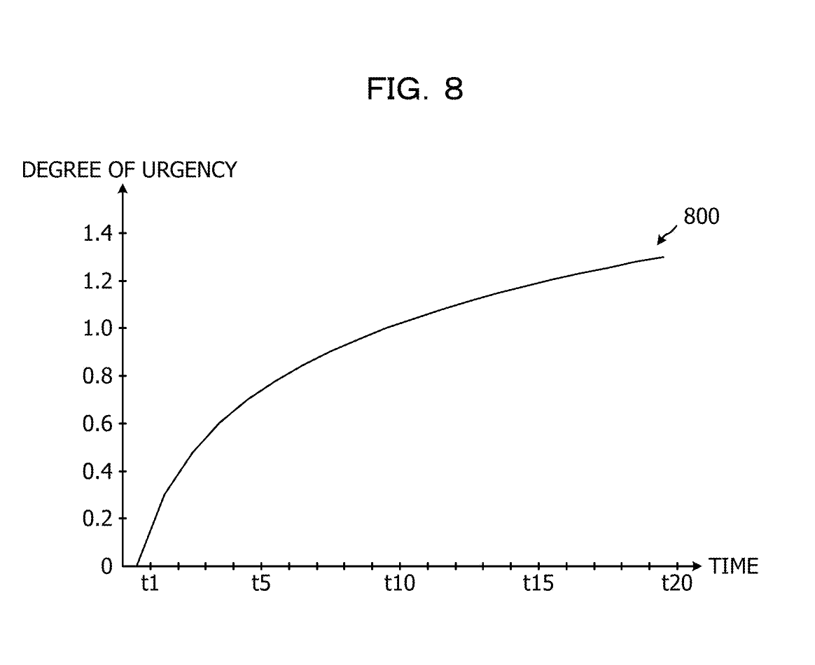

Further, as illustrated in FIG. 8, the closer to the time of occurrence of the failure case Bi the time is, the higher the degree of temporal urgency up to the occurrence of the failure case Bi is. FIG. 8 is an explanatory diagram illustrating the degree of temporal urgency up to the occurrence of the failure case Bi. FIG. 8 illustrates a graph 800 representing a change over time of a degree of temporal urgency up to the occurrence of the failure case Bi. In FIG. 8, the vertical axis represents the degree of temporal urgency up to the occurrence of the failure case Bi, and the horizontal axis represents the time tj corresponding to the old monitoring data item Gᵢⱼ.

According to the graph 800, as the time tj corresponding to the old monitoring data item Gᵢⱼ approaches the time of occurrence of the failure case Bi (a time t20 in this case), the degree of urgency exponentially increases. Therefore, with the use of the following equation (4), for example, the weight calculation unit 507 may calculate the weight representing the degree of temporal urgency up to the occurrence of the failure case Bi. Herein, Aᵢⱼ represents the weight representing the degree of temporal urgency of the old monitoring data item Gᵢⱼ up to the occurrence of the failure case Bi.

Aᵢⱼ=(1+log(j)) (4)

In the above equation (4), j represents an integer from 1 to n. That is, as the time tj corresponding to the old monitoring data item Gᵢⱼ approaches the time of occurrence of the failure case Bi (the time tn) (the value j of the time tj increases in this case), the weight Aᵢⱼ increases.

Further, the similarity degree calculation unit 502 may calculate the similarity degree of the weighted old monitoring data item Gᵢⱼ by using the calculated weight Aᵢⱼ of the old monitoring data item Gᵢⱼ and the similarity degree Rᵢⱼ of the old monitoring data item G. Specifically, for example, with the use of the following equation (5), the similarity degree calculation unit 502 can calculate the similarity degree of the weighted old monitoring data item Gᵢⱼ. Herein, R′ᵢⱼ represents the similarity degree of the weighted old monitoring data item Gᵢⱼ.

R′ᵢⱼ=Aᵢⱼ×Rᵢⱼ (5)

According to the above equation (5), as the time tj corresponding to the old monitoring data item Gᵢⱼ approaches the time of occurrence of the failure case Bi, the similarity degree R′ᵢⱼ of the weighted old monitoring data item Gᵢⱼ increases. The similarity degree R′ᵢⱼ of the weighted old monitoring data item Gᵢⱼ is stored in, for example, the similarity degree table 600 illustrated in FIG. 6.

Further, the determination unit 503 may determine, among the failure cases B1 to Bm, the failure case Bi predicted to occur in the monitored device 102-k, on the basis of the similarity degree R′ᵢⱼ of the weighted old monitoring data item Gᵢⱼ. With this configuration, it is possible to identify the failure predicted to occur in the future in the monitored device 102-k, in consideration of the degree of temporal urgency up to the occurrence of the failure.

Further, the weight calculation unit 507 has a function of calculating, for the individual failure case Bi, the weight representing the degree of variation among similarity degrees Rᵢ₁ to Rᵢₙ, of the group of old monitoring data items Gᵢ₁ to Gᵢₙ. Herein, patterns of a change in the similarity degree up to the occurrence of a failure are similar to one another in chronological order. It is therefore assumed that a high similarity degree at a certain time point does not necessarily guarantee that the failure will occur. That is, in the failure case Bi, the similarity degrees Rᵢ₁ to Rᵢₙ, regularly changing in chronological order, as in 10, 20, 30, and so forth, are determined to be appropriate. Meanwhile, in the failure case Bi, the similarity degrees Rᵢ₁ to Rᵢₙ irregularly changing in chronological order, as in 20, 80, 10, and so forth, are determined to be inappropriate.

Specifically, for example, with the use of the following equation (6), the weight calculation unit 507 may calculate the weight representing the degree of variation among the similarity degrees Rᵢ₁ to Rᵢₙ by calculating the sum of the differences between chronologically successive old monitoring data items Gᵢⱼ and Gᵢ₍ⱼ₊₁₎. Herein, Dᵢ, represents the weight representing the degree of variation among the similarity degrees Rᵢ₁ to Rᵢₙ.

$${D}_{i} = {\sum }_{j = 1}^{n - 1} ( {R}_{ij} - {R}_{i ( j + 1 )} ) \qquad ( 6 )$$

Further, the similarity degree calculation unit 502 may calculate the similarity degree Rᵢⱼ of the weighted old monitoring data item Gᵢⱼ by using the calculated weight Dᵢ of the failure case Bi and the similarity degree of the old monitoring data item Gᵢⱼ. Specifically, for example, with the use of the following equation (7), the similarity degree calculation unit 502 can calculate the similarity degree R′ᵢⱼ.

R′ᵢⱼ=Rᵢⱼ/Dᵢ (7)

According to the above equation (7), as the weight Dᵢ representing the degree of variation among the similarity degrees Rᵢ₁ to Rᵢₙ increases, the similarity degree R′ᵢⱼ of the weighted old monitoring data item Gᵢⱼ decreases. Accordingly, it is possible to exclude, from prediction candidates, the failure case Bi having a large variation among the similarity degrees Rᵢ₁ to Rᵢₙ, of the group of old monitoring data items Gᵢ₁ to Gᵢₙ.

Subsequently, an example of a method of constructing the failure case DB 120 will be described. Herein, description will be made of a method of registering a failure case data item in the failure case DB 120 in accordance with the operations (1) to (5) described below.

(1) Upon receipt of a monitoring data item from the monitored device 102-k, the monitoring device 101 stores the monitoring data item in the monitoring data DB 110 in association with the identifier of the monitored device 102-k. The monitoring data DB 110 stores, for the individual monitored device 102-k, a group of monitoring data items of a predetermined period.

(2) Upon receipt of a failure data item from the monitored device 102-k, the monitoring device 101 refers to the failure case DB 120, and determines whether or not the failure case data item corresponding to the failure name included in the failure data item has been registered. It is assumed herein that the failure case data item corresponding to the failure name included in the failure data item has not been registered in the failure case DB 120.

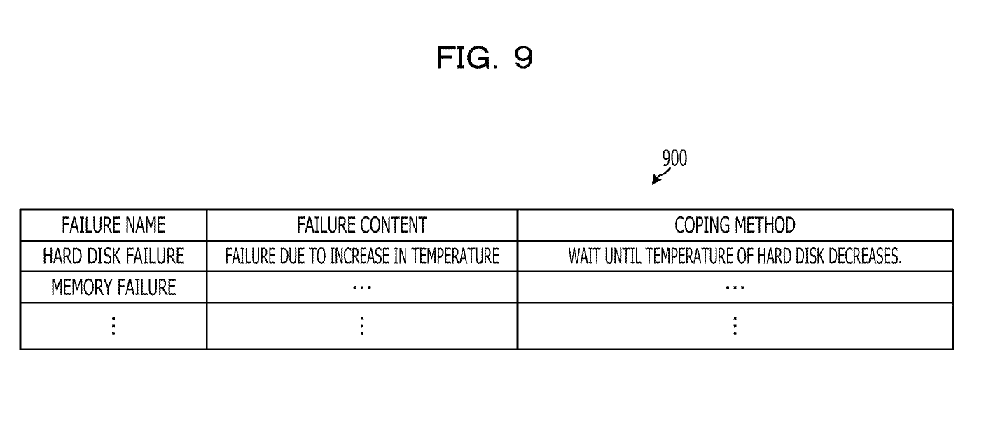

(3) With reference to a failure list 900 illustrated in FIG. 9, the monitoring device 101 identifies the failure content and the coping method from the failure name included in the failure data item. FIG. 9 is an explanatory diagram illustrating an example of content stored in the failure list 900. The failure list 900 stores a list of failure contents and coping methods of respective failures.

(4) The monitoring device 101 extracts, from the monitoring data DB 110, a group of monitoring data items of a predetermined period, and creates a failure case data item including a failure name, a failure content, and a coping method. (5) The monitoring device 101 registers the created failure case data item in the failure case DB 120. Thereby, it is possible to automatically create and register the failure case data item in the failure case DB 120.

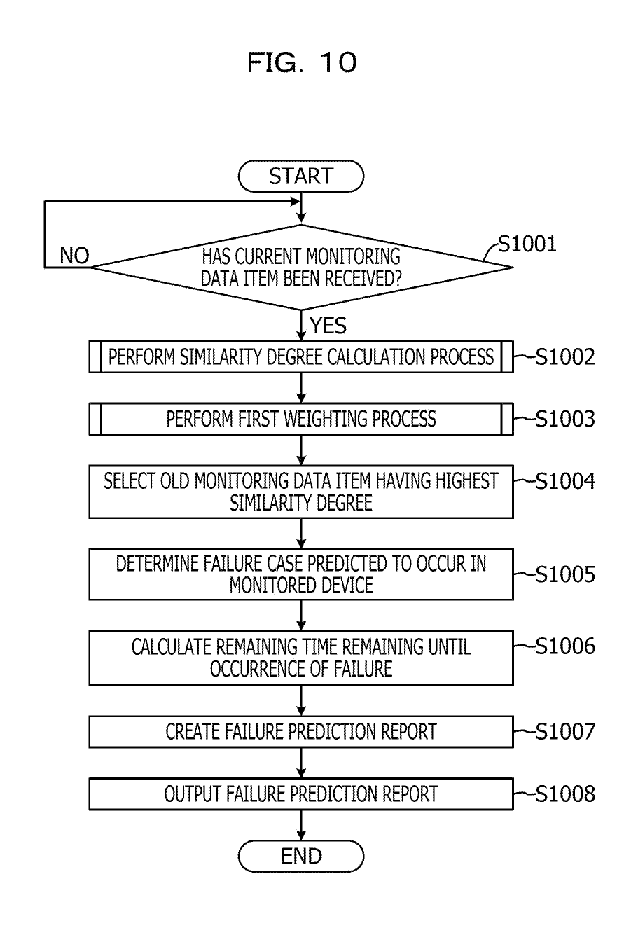

Subsequently, the monitoring process procedure by the monitoring device 101 will be described. FIG. 10 is a flowchart illustrating an example of a monitoring process procedure by the monitoring device 101, for example. In the flowchart of FIG. 10, whether or not the receiving unit 501 has received a current monitoring data item from the monitored device 102-k is first determined (Operation S1001).

Herein, reception of the current monitoring data item is waited for (NO at Operation S1001). Then, if the current monitoring data item is received (YES at Operation S1001), the similarity degree calculation unit 502, for example, performs a similarity degree calculation process to calculate the similarity degree Rᵢⱼ between the old monitoring data item Gᵢⱼ and the current monitoring data item (Operation S1002).

Thereafter, the similarity degree calculation unit 502 performs a first weighting process relating to the degree of temporal urgency up to the occurrence of the failure case Bi (Operation S1003). Then, with reference to the similarity degree table 600, the selection unit 504 selects, from all of the old monitoring data items, the old monitoring data item Gᵢⱼ having a highest similarity degree (Operation S1004).

Then, with reference to the failure case DB 120, the determination unit 503 determines the failure case Bi corresponding to the selected old monitoring data item Gᵢⱼ to be the failure case predicted to occur in the monitored device 102-k (Operation S1005).

Thereafter, the remaining time calculation unit 505 calculates a time interval between the time tj corresponding to the selected old monitoring data item Gᵢⱼ and the time tn representing the time of occurrence of the determined failure case Bi, to thereby calculate a time remaining until the occurrence of the failure in the monitored device 102-k (Operation S1006).

Then, the creation unit 506 creates a failure prediction report (Operation S1007), and the output unit 508 outputs the created failure prediction report (Operation S1008). Thereby, the series of processes according to the present flowchart is completed.

Accordingly, it is possible to inform a user of the failure predicted to occur in the future in the monitored device 102-k.

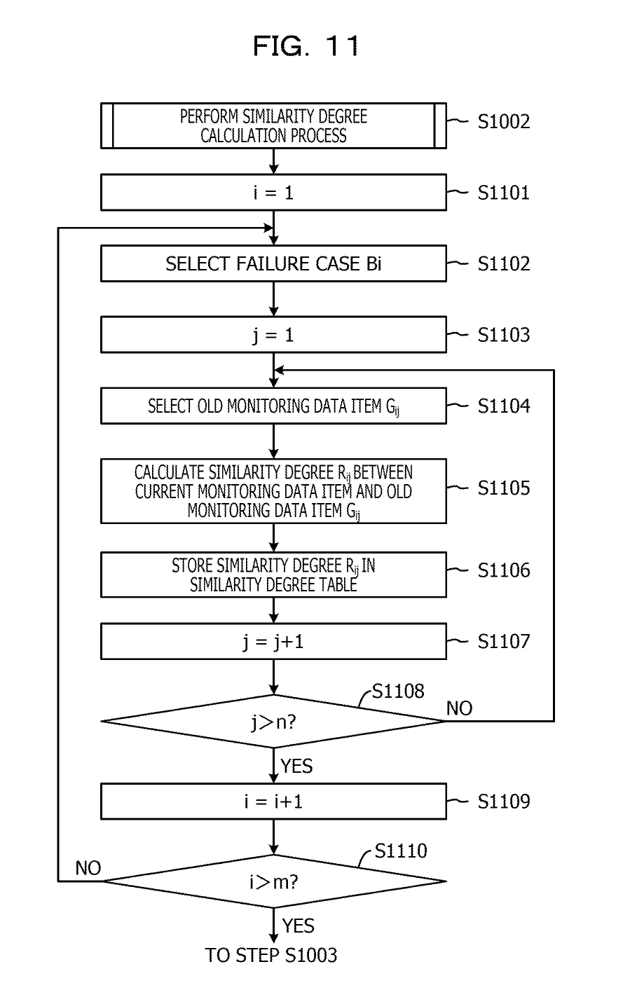

Subsequently, description will be made of a specific process procedure of the similarity degree calculation process of Operation S1002 illustrated in FIG. 10. FIG. 11 is a flowchart illustrating an example of a specific process procedure of a similarity degree calculation process. In the flowchart of FIG. 11, the similarity degree calculation unit 502 first sets the value i to 1 (Operation S1101), and selects the failure case Bi from the failure cases B1 to Bm by referring to the failure case DB 120 (Operation S1102).

Thereafter, the similarity degree calculation unit 502 sets the value j to 1 (Operation S1103), and selects the old monitoring data item Gᵢⱼ by referring to the failure case DB 120 (Operation S1104). Then, with the use of the foregoing equation (1), the similarity degree calculation unit 502 calculates the similarity degree Rᵢⱼ between the current monitoring data item and the old monitoring data item Gᵢⱼ (Operation S1105), and stores the calculated similarity degree Rᵢⱼ in the similarity degree table 600 (Operation S1106).

Then, the similarity degree calculation unit 502 increments the value j (Operation S1107), and determines whether or not a relationship j>n holds (Operation S1108). Herein, if a relationship j≦n holds (NO at Operation S1108), the procedure returns to Operation S1104.

Meanwhile, if the relationship j>n holds (YES at Operation S1108), the similarity degree calculation unit 502 increments the value i (Operation S1109), and determines whether or not a relationship i>m holds (Operation S1110). Herein, if a relationship i≦m holds (NO at Operation S1110), the procedure returns to Operation S1102. Meanwhile, if the relationship i>m holds (YES at Operation S1110), the procedure proceeds to Operation S1003 illustrated in FIG. 10.

Thereby, it is possible to quantitatively calculate the similarity degree Rᵢⱼ between the current monitoring data item and the old monitoring data item Gᵢⱼ.

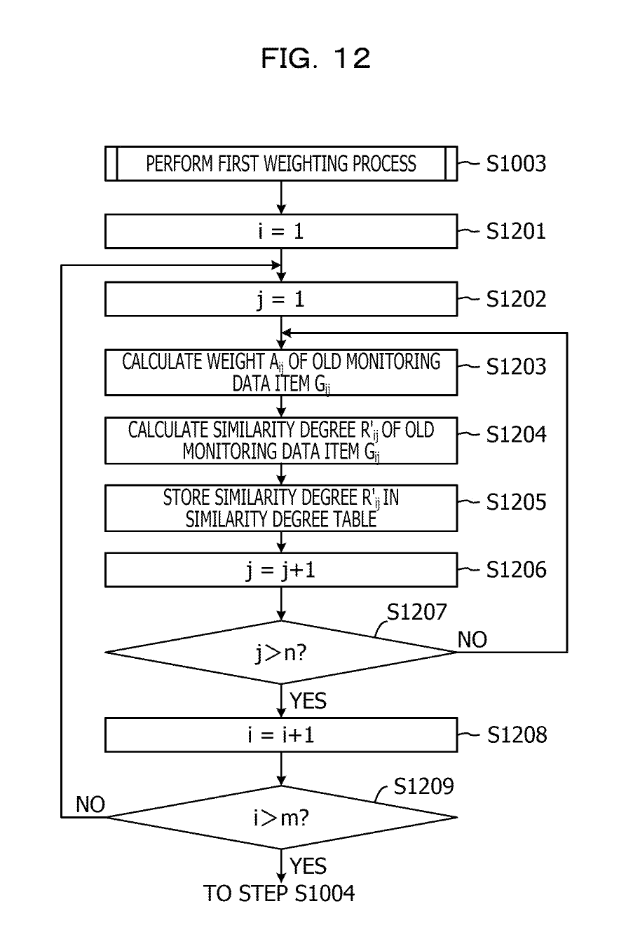

Subsequently, description will be made of a specific process procedure of the first weighting process of Operation S1003 illustrated in FIG. 10. FIG. 12 is a flowchart illustrating an example of a specific process procedure of a first weighting process. In the flowchart of FIG. 12, the weight calculation unit 507 first sets the value i to 1 (Operation S1201), and sets the value j to 1 (Operation S1202).

Thereafter, with the use of the foregoing equation (4), the weight calculation unit 507 calculates the weight Aᵢⱼ representing the degree of temporal urgency of the old monitoring data item Gᵢⱼ (Operation S1203). Then, with the use of the foregoing equation (5), the similarity degree calculation unit 502 calculates the similarity degree R′ᵢⱼ of the weighted old monitoring data item Gᵢⱼ (Operation S1204), and stores the calculated similarity degree in the similarity degree table 600 (Operation S1205).

Then, the weight calculation unit 507 increments the value j (Operation S1206), and determines whether or not a relationship j>n holds (Operation S1207). Herein, if a relationship j≦n holds (NO at Operation S1207), the procedure returns to Operation S1203.

Meanwhile, if the relationship j>n holds (YES at Operation S1207), the weight calculation unit 507 increments the value i (Operation S1208), and determines whether or not a relationship i>m holds (Operation S1209). Herein, if a relationship i≦m holds (NO at Operation S1209), the procedure returns to Operation S1202. Meanwhile, if the relationship i>m holds (YES at Operation S1209), the procedure proceeds to Operation S1004 illustrated in FIG. 10.

Accordingly, it is possible to predict the failure which will occur in the future in the monitored device 102-k, in consideration of the degree of temporal urgency up to the occurrence of the failure.

Subsequently, another monitoring process procedure by the monitoring device 101 will be described. In the flowchart of FIG. 10, description has been made of the example in which the similarity degree Rᵢⱼ is weighted in consideration of the degree of temporal urgency up to the occurrence of the failure case Bi. Herein, description will be made of an example in which the weighting is performed also in consideration of the degree of variation among the similarity degrees Rᵢ₁ to Rᵢₙ.

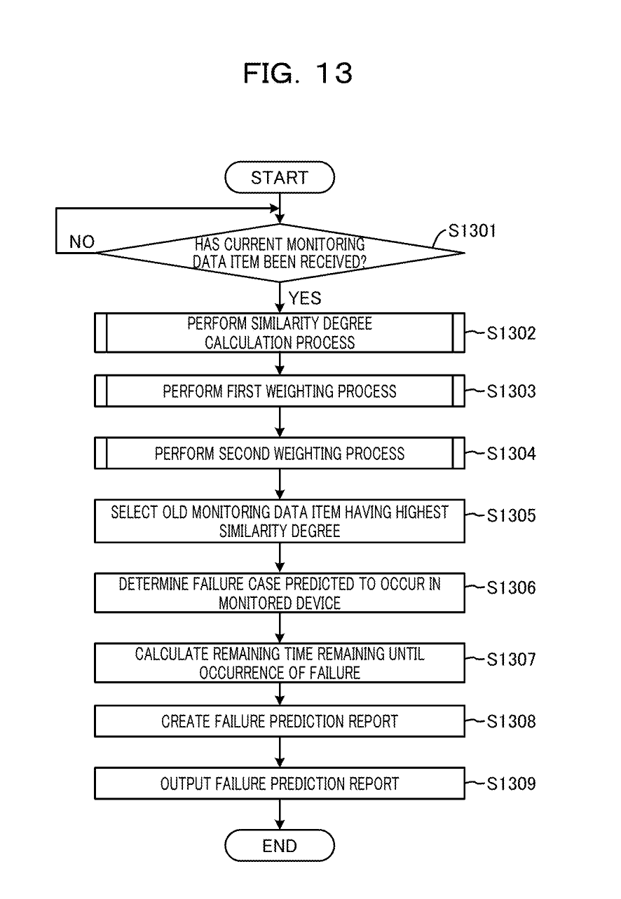

FIG. 13 is a flowchart illustrating an example of another monitoring process procedure by the monitoring device 101. In the flowchart of FIG. 13, whether or not the receiving unit 501 has received the current monitoring data item from the monitored device 102-k is first determined (Operation S1301).

Herein, the reception of the current monitoring data item is waited for (NO at Operation S1301). Then, if the current monitoring data item is received (YES at Operation S1301), the similarity degree calculation unit 502 performs a similarity degree calculation process to calculate the similarity degree Rᵢⱼ between the old monitoring data item Gᵢⱼ and the current monitoring data item (Operation S1302).

Thereafter, the similarity degree calculation unit 502 performs a first weighting process relating to the degree of temporal urgency up to the occurrence of the failure case Bi (Operation S1303). Then, the similarity degree calculation unit 502 performs, for the individual failure case Bi, a second weighting process relating to the degree of variation among the similarity degrees Rᵢ₁ to Rᵢₙ of the group of old monitoring data items Gᵢ₁ to Gᵢₙ (Operation S1304).

Then, with reference to the similarity degree table 600, the selection unit 504 selects, from all of the old monitoring data items, the old monitoring data item Gᵢⱼ having the highest similarity degree (Operation S1305). Then, with reference to the failure case DB 120, the determination unit 503 determines the failure case Bi corresponding to the selected old monitoring data item to be the failure case predicted to occur in the monitored device 102-k (Operation S1306).

Thereafter, the remaining time calculation unit 505 calculates the time interval between the time tj corresponding to the selected old monitoring data item Gᵢⱼ and the time tn representing the time of occurrence of the determined failure case Bi, to thereby calculate the remaining time remaining until the occurrence of the failure in the monitored device 102-k (Operation S1307).

Then, the creation unit 506 creates a failure prediction report (Operation S1308), and the output unit 508 outputs the created failure prediction report (Operation S1309). Thereby, the series of processes according to the present flowchart is completed.

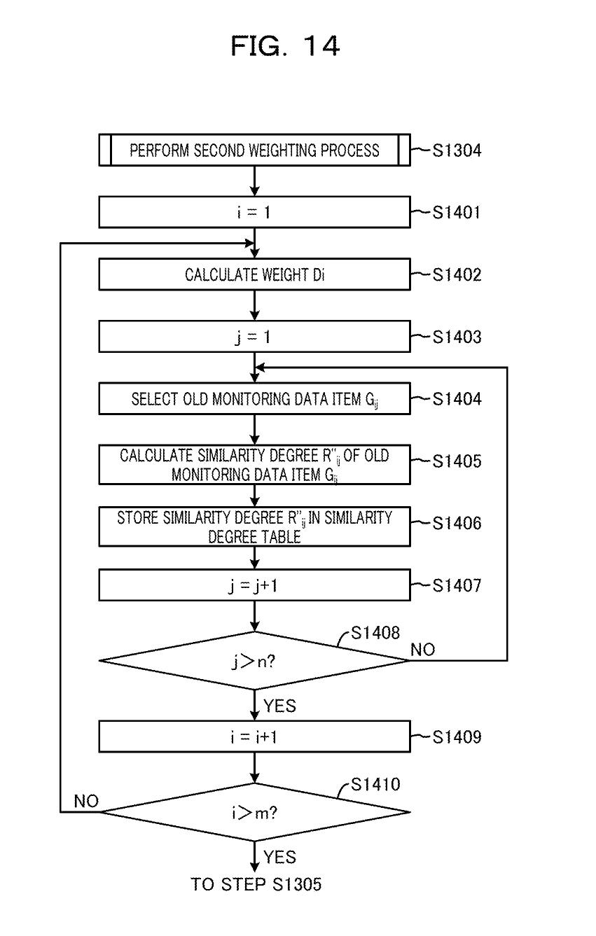

Subsequently, description will be made of a specific process procedure of the second weighting process of Operation S1304 illustrated in FIG. 13. FIG. 14 is a flowchart illustrating an example of a specific process procedure of the second weighting process.

In the flowchart of FIG. 14, the weight calculation unit 507 first sets the value i to 1 (Operation S1401), and calculates the weight Dᵢ, representing the degree of variation among the similarity degrees Rᵢ₁ to Rᵢₙ by using the foregoing equation (6) (Operation S1402). Then, the similarity degree calculation unit 502 sets the value j to 1 (Operation S1403), and selects the old monitoring data item Gᵢⱼ by referring to the failure case DB 120 (Operation S1404).

Thereafter, with the use of the following equation (8), the similarity degree calculation unit 502 calculates a similarity degree R″ᵢⱼ of the weighted old monitoring data item Gᵢⱼ (Operation S1405), and stores the calculated similarity degree R″ᵢⱼ in the similarity degree table 600 (Operation S1406).

R″ᵢⱼ=R′ᵢⱼ/Dᵢ (8)

Then, the similarity degree calculation unit 502 increments the value j (Operation S1407), and determines whether or not a relationship j>n holds (Operation S1408). Herein, if a relationship j≦n holds (NO at Operation S1408), the procedure returns to Operation S1404.

Meanwhile, if the relationship j>n holds (YES at Operation S1408), the weight calculation unit 507 increments the value i (Operation S1409), and determines whether or not a relationship i>m holds (Operation S1410). Herein, if a relationship i≦m holds (NO at Operation S1410), the procedure returns to Operation S1402. Meanwhile, if the relationship i>m holds (YES at Operation S1410), the procedure proceeds to Operation S1305 illustrated in FIG. 13.

Accordingly, it is possible to exclude, from the prediction candidates, the failure case Bi having a large variation among the similarity degrees R_{H} to Rᵢₙ of the group of old monitoring data items Gᵢ₁ to Gᵢₙ.

As described above, a disclosed technique of an embodiment calculates a similarity degree between each of the old monitoring data items stored in the failure case DB 120 and the current monitoring data item on the basis of the respective measured values of the plurality of monitoring items, and determines, among the failure cases B1 to Bm, the failure case Bi predicted to occur in the monitored device 102-k. With this configuration, it is possible to inform a user of the failure predicted to occur in the future in the monitored device 102-k.

Further, a disclosed technique of an embodiment may calculate the similarity degree Rᵢⱼ by converting the current monitoring data item and the old monitoring data item Gᵢⱼ into multidimensional vectors with the use of the plurality of monitoring items as vector components and calculating the inter-vector distance between the current monitoring data item and the old monitoring data item Gᵢⱼ. With this configuration, it is possible to quantitatively calculate the similarity degree Rᵢⱼ between the current monitoring data item and the old monitoring data item Gᵢⱼ.

Further, a disclosed technique of an embodiment may select, from all of the old monitoring data items, the old monitoring data item Gᵢⱼ similar to the current monitoring data item on the basis of the similarity degree between each of the old monitoring data items and the current monitoring data item, and may determine the failure case Bi corresponding to the old monitoring data item Gᵢⱼ to be the failure case predicted to occur in the future. With this configuration, it is possible to predict, as the failure case which will occur in the future, the failure case occurred in an operating state similar to the current operating state of the monitored device 102-k.

Further, a disclosed technique of an embodiment may select, from all of the old monitoring data items, the old monitoring data item Gᵢⱼ having the highest similarity degree. With this configuration, it is possible to predict, as the failure case which will occur in the future, the failure case occurred in an operating state most similar to the current operating state of the monitored device 102-k.

Further, a disclosed technique of an embodiment may calculate a time interval between a time of measurement of the selected old monitoring data item Gᵢⱼ and the time of occurrence of the determined failure case Bi, to thereby calculate a time remaining until the occurrence of the failure case Bi. With this configuration, it is possible to inform a user of the remaining time remaining until the occurrence of the failure in the monitored device 102-k.

Further, a disclosed technique of an embodiment may weight the similarity degree Rᵢⱼ by calculating, on the basis of the time of occurrence of the failure case Bi corresponding to the old monitoring data item Gᵢⱼ and the time of measurement of the old monitoring data item the weight Aᵢⱼ representing the degree of temporal urgency up to the occurrence of the failure. With this configuration, it is possible to predict the failure which will occur in the future in the monitored device 102-k, in consideration of the degree of temporal urgency up to the occurrence of the failure.

Further, a disclosed technique of an embodiment may weight the similarity degree Rᵢⱼ by calculating the weight Dᵢ representing the degree of variation among the similarity degrees Rᵢ₁ to Rᵢₙ of the group of chronologically successive old monitoring data items Gᵢ₁ to Gᵢₙ. With this configuration, it is possible to exclude, from the prediction candidates, the failure case Bi having a large variation among the similarity degrees Rᵢ₁ to Rᵢₙ of the group of old monitoring data items Gᵢ₁ to Gᵢₙ.

In view of the above, according to a technique of an embodiment, it is possible to predict the failure which will occur in the monitored device 102-k and the remaining time remaining until the occurrence of the failure, and thus to take appropriate prior measures before the occurrence of the failure.

Specifically, for example, if a given situation is not determined urgent on the basis of a time remaining until the occurrence of the failure, the monitoring period may be extended. Thereby, it is possible to reduce the load on the network and the monitoring server required for the monitoring operation. Meanwhile, if a given situation is determined urgent, it is possible to take prompt prior measures for the monitored device 102-k.

Further, with the presentation of the method for coping with the failure, it is possible to take appropriate prior measures, such as the pre-check of the presence of a replacement hard disk in the case of a hard disk failure, for example. As a result, the data center 100 is capable of providing customers with a seamless and high-quality service.

An embodiment includes a monitoring method performed by a computer to execute operations including predicting a failure of a first device when a stored one of failure occurrence items matches a current measured value, and transferring an operation of the first device to a second device when the predicting indicates an error in the first device.

The monitoring according to an embodiment can be realized by a previously prepared program executed by a computer, such as a personal computer and a work station. The present monitoring program is recorded in a computer-readable recording medium, such as a hard disk, a flexible disk, a CD (Compact Disk)-ROM, an MO (Magneto-Optical disk), and a DVD (Digital Versatile Disk), and is read from the recording medium by a computer to be executed. Further, the present monitoring program may be distributed via a network, such as the Internet.

Accordingly, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising tangible computer-readable recording media. The program/software implementing the embodiments may also be transmitted over transmission communication media. Examples of the tangible computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention, the scope of which is defined in the claims and their equivalents.

What is claimed is:

1. A tangible computer-readable recording medium storing therein a monitoring program that causes a computer to execute a procedure, comprising:
accessing a database storing, for each of a plurality of failure cases that occurred in a monitored device, a group of past monitoring data items each representing respective measured values of a plurality of monitoring items of the monitored device measured until a time of an occurrence of a failure case;
receiving, from the monitored device, a current monitoring data item representing current measured values of the plurality of monitoring items;
calculating, for each of the past monitoring data items stored in the database, a similarity degree between a past monitoring data item and the current monitoring data item based on the respective measured values of the plurality of monitoring items;
determining, among the plurality of failure cases, a failure case predicted to occur in the monitored device, based on a result of the calculating; and
outputting a result of the determining.

2. The tangible computer-readable recording medium according to claim 1, wherein the calculating includes calculating the similarity degree by converting the current monitoring data item and the past monitoring data item into multidimensional vectors using the plurality of monitoring items as vector components, and calculating an inter-vector distance between the current monitoring data item and the past monitoring data item.

3. The tangible computer-readable recording medium according to claim 1, comprising:
selecting, from all of the past monitoring data items, a past monitoring data item similar to the current monitoring data item based on the result of the calculating; and
calculating a time remaining until the occurrence of the failure case predicted to occur in the monitored device, and
wherein the determining includes determining the failure case corresponding to the selected past monitoring data item to be the failure case predicted to occur in the monitored device,
wherein the calculating of the time remaining includes calculating a time interval between a time of measurement of the selected past monitoring data item and the time of occurrence of the determined failure case, to thereby calculate the time remaining until the occurrence of the failure case, and
wherein the outputting includes outputting the result of said determining and the calculated remaining time.

4. The tangible computer-readable recording medium according to claim 3, wherein the selecting includes selecting, from all of the past monitoring data items, a past monitoring data item having a highest similarity degree.

5. The tangible computer-readable recording medium according to claim 1, comprising:
calculating, for each of the past monitoring data items, a weight representing a degree of temporal urgency up to the occurrence of the failure case, based on the time of occurrence of the failure case corresponding to the past monitoring data item and a time of measurement of the past monitoring data item,
wherein the calculating of the similarity degree includes calculating, using the calculated weight of each of the past monitoring data items and the similarity degree of the past monitoring data item, the similarity degree of the weighted past monitoring data item, and
wherein the determining includes determining, among the plurality of failure cases, the failure case predicted to occur in the monitored device, based on the calculated weighted similarity degree.

6. The tangible computer-readable recording medium according to claim 5, wherein for each of the failure cases, a weight representing a degree of variation among the similarity degrees of a group of chronologically successive past monitoring data items is calculated, and
wherein, using the weight calculated for each of the failure cases and the similarity degree of the past monitoring data item, the similarity degree of the weighted past monitoring data item is calculated.

7. A monitoring device, comprising:
a storage that stores, for each of a plurality of failure cases that have occurred in a monitored device, a group of past monitoring data items each representing respective measured values of a plurality of monitoring items of the monitored device measured until a time of an occurrence of a failure case; and
a processor configured to receive, from the monitored device, a current monitoring data item representing current measured values of the plurality of monitoring items, to calculate, for each of the past monitoring data items stored in the storage, a similarity degree between a past monitoring data item and the current monitoring data item based on the respective measured values of the plurality of monitoring items, to determine, among the plurality of failure cases, a failure case predicted to occur in the monitored device, based on a calculation result, and to output a determination result.

8. A monitoring method performed by a computer, comprising:
accessing a database storing, for each of a plurality of failure cases that occurred in a monitored device, a group of past monitoring data items each representing respective measured values of a plurality of monitoring items of the monitored device measured until a time of an occurrence of a failure case;
receiving, from the monitored device, a current monitoring data item representing current measured values of the plurality of monitoring items, and storing the current monitoring data item in the database;
calculating, for each of the past monitoring data items stored in the database, a similarity degree between a past monitoring data item and a current monitoring data item based on the respective measured values of the plurality of monitoring items, and storing the similarity degree in the database;
determining, using a processor, among the plurality of failure cases, a failure case predicted to occur in the monitored device, based on a result of said calculating, and storing the failure case in the database; and
outputting a result of the determining.

9. A monitoring method performed by a computer, comprising:
predicting a failure of a first device when a stored one of failure occurrence items matches a current measured value; and
transferring, using a processor, an operation of the first device to a second device when said predicting indicates an error in the first device.
